(19) United States
(12) Patent Application Publication
(10) Pub. No.: US 2022/0156854 A1
(43) Pub. Date: May 19, 2022

(54) INFORMATION PROCESSING SYSTEM, INFORMATION PROCESSING APPARATUS, SORTING METHOD, AND RECORDING MEDIUM STORING PROGRAM

(71) Applicant: Akio ISHIDA, Tokyo (JP)

(72) Inventor: Akio ISHIDA, Tokyo (JP)

(21) Appl. No.: 17/522,910

(22) Filed: Nov. 10, 2021

(30) Foreign Application Priority Data
Nov. 16, 2020 (JP) 2020-190017

(51) Int. Cl. G06Q 50/04; G06Q 10/06

(52) U.S. Cl. CPC G06Q 50/04; G06Q 10/06315

(57) ABSTRACT

An information processing system, an information processing apparatus, a sorting method, and a recording medium storing a program. The information processing system includes circuitry configured to sort a plurality of orders to at least one production site based on a degree of environmental load when a prescribed condition is satisfied, and send a request for production of a product, the request being included in each of the plurality of orders, to the at least one production site. The information processing device includes the circuitry. The sorting method includes sorting a plurality of orders to at least one production site based on a degree of environmental load when a prescribed condition is satisfied, and sending a request for production of a product, the request being included in each of the plurality of orders, to the at least one production site.

### CROSS-REFERENCE TO RELATED APPLICATION

This patent application is based on and claims priority pursuant to 35 U.S.C. § 119(a) to Japanese Patent Application No. 2020-190017, filed on Nov. 16, 2020, in the Japan Patent Office, the entire disclosure of which is hereby incorporated by reference herein.

### BACKGROUND

### Technical Field

Embodiments of the present disclosure relate to an information processing system, an information processing apparatus, a sorting method, and a recording medium storing a program.

### Background Art

For example, in the textiles and apparel industry, there has been a demand for reduction in excessive production and disposal of products in large quantity caused by the production based on expectations. For the purposes of reducing such excessive production or disposal of waste in large quantity, production on order or on-demand production in which products are produced at a production site in response to each order is effective. In production on order, when an electronic-commerce (EC) site or the like receives an order for a product such as clothes or garment, that EC site or the like places an order with a production site.

For example, a technology that an information processing system dynamically selects a production site to which an order is placed is known in the art. More specifically, EC sites are known in the art that exclusively accept various kinds of print orders with different quantity scales or required specifications and distribute such orders to printing facilities optimal for dealing with the orders.

### SUMMARY

Embodiments of the present disclosure described herein provide an information processing system, an information processing apparatus, a sorting method, and a recording medium storing a program. The information processing system includes circuitry configured to sort a plurality of orders to at least one production site based on a degree of environmental load when a prescribed condition is satisfied, and send a request for production of a product, the request being included in each of the plurality of orders, to the at least one production site. The information processing device includes the circuitry. The sorting method includes sorting a plurality of orders to at least one production site based on a degree of environmental load when a prescribed condition is satisfied, and sending a request for production of a product, the request being included in each of the plurality of orders, to the at least one production site.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a schematic diagram illustrating an operation of an information processing system according to an embodiment of the present disclosure.

FIG. 2 is a block diagram of an order system according to an embodiment of the present disclosure.

FIG. 3 is a block diagram illustrating a hardware configuration of an order receiving system, an information processing system, a production site system, and a terminal device according to an embodiment of the present disclosure.

FIG. 4 is a functional block diagram of an order receiving system, an information processing system, and a production site system according to an embodiment of the present disclosure.

FIG. 5 is a diagram illustrating order information stored in an order storage database, according to an embodiment of the present disclosure.

FIG. 6 is a diagram depicting the production site data stored in an production site database (DB), according to an embodiment of the present disclosure.

FIG. 7 is a diagram depicting the customer information stored in a customer information database (DB), according to an embodiment of the present disclosure.

FIG. 8 is a diagram depicting a conversion table included in a conversion table database (DB), according to an embodiment of the present disclosure.

FIG. 9 is a flowchart of the processes of sorting a plurality of items of order information received by an information processing system into groups of orders for each production site at a prescribed timing so as to minimize or at least reduce the environmental load and requesting each of the production sites to produce the products specified by the orders, according to an embodiment of the present disclosure.

FIG. 10 is a table in which the items of order management information are listed, according to an embodiment of the present disclosure.

FIG. 11 is a diagram depicting a table of the detailed contents of material information obtained as a result of performing conversion on the order information, according to an embodiment of the present disclosure.

FIG. 12 is a diagram depicting production site data according to an embodiment of the present disclosure.

FIG. 13A, FIG. 13B, and FIG. 13C are matrix tables in which several items of material information such as types of fabric, sizes, colors, and sub-materials are arranged, according to an embodiment of the present disclosure.

FIG. 14A, FIG. 14B, and FIG. 14C are matrix tables in which several items of capability in view of types of fabric, sizes, colors, and sub-materials are arranged, according to an embodiment of the present disclosure.

FIG. 15 is a diagram depicting a table of production sites capable of production that are determined for five orders of order numbers 001 to 005, according to an embodiment of the present disclosure.

FIG. 16 is a table depicting the environmental load for each of the thirty-two sorting patterns, according to an embodiment of the present disclosure.

FIG. 17A and FIG. 17B are matrix tables where sub-materials are grouped, according to an embodiment of the present disclosure.

FIG. 18 is a diagram illustrating a screen displayed on a terminal device of a consumer to select an ordering method, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific integrated circuits (ASICs), field-programmable gate arrays (FPGAs), computers or the like. These terms may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Embodiments of the present disclosure are described below with reference to the accompanying drawings. Firstly, an information processing system and a method of sorting orders implemented by the information processing system are described below.

Firstly, supplemental comments are given in relation to the production on order. In the production on order, when a manager who determines a producer requests a producer to produce products, the manager tends to select a producer that has track record in business transaction. For this reason, producers at a place close to the place where products are consumed are not always selected.

Even if the manager tries to find a producer in an area close to the places where products are consumed, the shipping addresses where products are consumed are different for each order. For this reason, it is necessary to check, for each order, whether or not there is any producer near the places where products are consumed. This causes a large man-hour load for the manager, and leads to a long lead time from the order to the reception of the product. For this reason, the above ordering method is not realistic. In a similar manner to the above, when a consumer orders through an electronic-commerce (EC) site, a producer who is close to the shipping address is not always selected, and the manager tends to request the production to a previously-selected producer.

As described above, both “production on order” and “local consumption of locally-grown food” are great means for reducing the environmental load. However, a production system in which both “production on order” and “local consumption of locally-grown food” are satisfied are not widespread. The reason for this is considered to be as follows.

The point of the reduction of the environmental load by the production on order lies in the point of not making products having no demand, and the waste can effectively be reduced. However, on the other hand, producing a small number of products in response to an order increases the waste in view of the processes in the production stage. Examples in textiles and apparel industry are given below in a concrete manner. The fabric that is set to, for example, a printer and a cutter may have various unit lengths, and if the fabric has a particular unit length that is frequently used for the product, the amount of disposal of fabric can be reduced. In order to increase the ratio of the fabric of a particular unit length that is frequently used for the product, it is effective to optimally impose as many products as possible to produce a plurality of products in one job. In other words, consolidation of production to the same production site can increase the effect of reducing environmental load in the production stage. The environmental load varies depending on the production machines. Typically, the environmental load is smaller in newer models.

On the other hand, the idea of local consumption of locally-grown food attempts to shorten the distance between the place where products are consumed and the place where products are produced. As a result, the transport mileage in the supply chain management (SCM) can be shortened to reduce the environmental load in the transport stage. In order to select a production site close to the place where products are consumed, it is desired that the production sites be distributed.

Accordingly, in order to achieve both “production on order” and “local consumption of locally-grown food,” it is necessary for the information processing system to satisfy two conflicting requirements, i.e., enhancing the consolidation of production sites and distributing the production sites near the place where products are consumed.

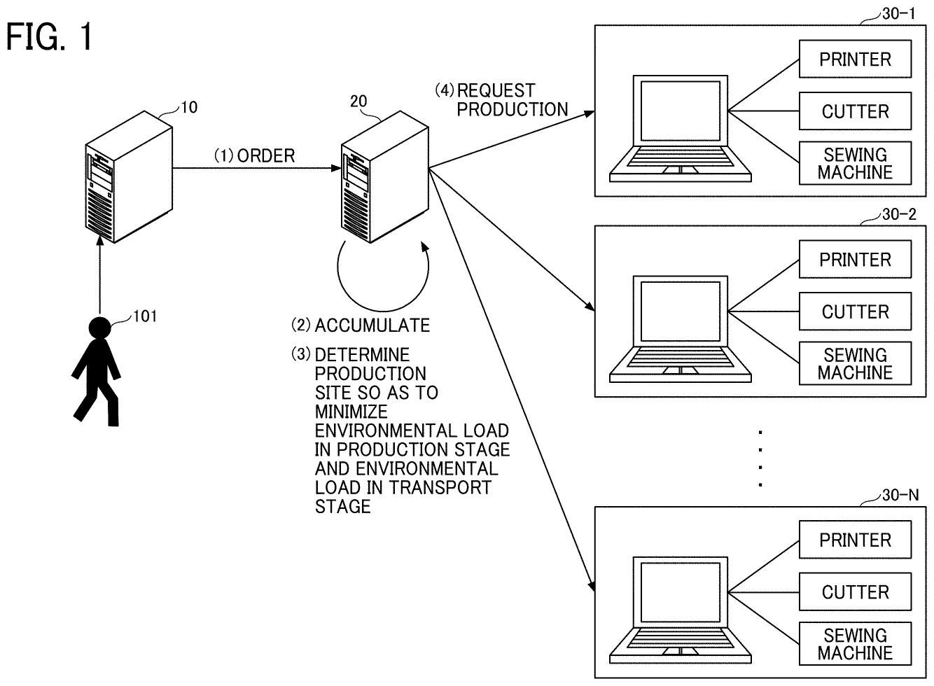

FIG. 1 is a schematic diagram illustrating an operation of an information processing system 20 according to an embodiment of the present disclosure.

As illustrated in FIG. 1, the information processing system 20 can communicate with one or more order receiving systems 10 and N production site systems 30 through the network.

In the first step, the order receiving system 10 receives an order from a consumer 101 and identify order information, and orders a product from the information processing system 20. The order information includes the shipping address.

In the second step, the information processing system 20 does not request production immediately after the reception of the order. Instead of that, in the second step, the information processing system 20 accumulates a plurality of orders, and sorts the accumulated multiple orders into groups of orders for each production site at a prescribed timing so as to minimize or at least reduce the environmental load. In other words, the production sites are consolidated to reduce the environmental load in the production stage.

In the third step, the information processing system 20 selects a producer with low environmental load when the products are delivered from the place where products are produced to the shipping address where products are consumed, based on the production site data of the producer stored in advance. Whether the environmental load is low is determined based on, for example, the distance in a straight line calculated from the latitude-longitude information, whether the city, town, or village is the same between the above two points, whether the transportation connecting the above two points is available, and whether the transportation is clean. As will be described later, such a low environmental load may be achieved by a reduction in the environmental load in the transport stage due to the reduction in transport mileage in the supply chain management (SCM).

In the fourth step, a request for production is sent to the selected production site system 30 selected by the information processing system 20. The determination as to whether or not the request should be sent to the selected producer may be finalized by a manager.

As described above, the information processing system 20 accumulates a plurality of orders. As a result, the information processing system 20 can easily consolidate the orders that involve the same material to one production site, and the usage rate of the material can be increased and the disposal of the material can be reduced. Such an effect may be referred to as a reduction in the environmental load in the production stage due to the consolidation of production sites.

The accumulated multiple orders are sorted into a production site close to a place where products are consumed. As the place where products are consumed and the production site are close to each other, the transport mileage in the supply chain management (SCM) can be shortened, and the environmental load in the transport stage can be reduced. Such an effect may be referred to as a reduction in the environmental load in the transport stage due to the reduction in transport mileage in the supply chain management (SCM).

In the present embodiment, all the orders that involve the same material are not always consolidated to one production site, and the production site closest to the place where products are consumed is not always selected for all orders. However, in the present embodiment, as will be described later, the orders are sorted to multiple production sites such that the sum of the environmental load in the production stage and the environmental load in the transport stage is minimized. More specifically, the information processing system 20 converts two kinds of data including the environmental load in the production stage and the environmental load in the transport stage into numerical values of the same parameter, and makes comparisons of the parameter values of each sorting pattern related to the environmental load. Additionally, the information processing system 20 may also take into consideration not only the production stage and the transport stage but also the other kinds of environmental load such as the environmental load in the production stage of materials. In such cases, the information processing system 20 may convert the environmental load in the production stage of materials into numerical values the same parameter. In the present embodiment, the environmental load in the supply chain management (SCM) other than the above environmental load in the production stage and the above environmental load in the transport stage may additionally be taken into consideration.

In order to convert the environmental load into numerical values, for example, the quantity of surplus fabric and the quantity of carbon dioxide discharged from each production machine may be taken in consideration to obtain numerical values for the environmental load in the production stage. For example, the energy consumption in transportation per unit distance that is multiplied by the length of route may be taken in consideration to obtain numerical values for the environmental load in the transport stage. The information processing system 20 converts both items into the same converted value such as the quantity of carbon dioxide emissions and energy consumption. If the cost increases as the quantity of carbon dioxide emissions or the energy consumption increases, the cost may be used as a parameter.

The prescribed timing may be, for example, a timing at which the number of orders has reached a predetermined order number of orders, a timing at which a certain length of time has passed, or a timing of a predetermined point in time. The timing may be determined by the information processing system 20 as appropriate in view of the balance between the request from the orderer and the environmental load, and the conditions may be changed for each order. For example, regarding the orders from an orderer who does not mind even if delivery date is slightly delayed as long as the environmental load of the product is low, the information processing system 20 may place an order when the number of orders has reached a predetermined number of orders. By contrast, regarding the orders from an orderer who give a high priority to the delivery date, the information processing system 20 may place an order when a certain length of time has passed.

The term “product” refers to a useful material that has some sort of physical or mental value or benefits in economics. The product is mainly a thing, but may include a service or an idea. In the present embodiment, clothes are referred to as a typical product. However, no limitation is indicated thereby, and the product according to the present embodiment may be anything including an information processing device such as a personal computer (PC) and a smartphone, electric home appliances such as a television or a refrigerator, and utensils such as tableware, dishes, and furniture as long as such a product can be ordered and produced. Alternatively, the product according to the present embodiment may be food dishes.

The term “order” means that a consumer specifies, for example, a product type, quantity, shape, and size of a product, and requests production or delivery of the product.

One order is placed when a consumer completes an ordering operation one time. Multiple orders are placed when a consumer completes an ordering operation multiple times. The term “ordering operation” means that, for example, a consumer clicks or taps a terminal device to confirm the order.

A plurality of products may be specified in one order. When multiple requests for producing a plurality of products are included in one order, the information processing system may divide the order into a plurality of orders on a product-by-product basis. In such cases, one order includes the requests for only one kind of product.

The term production site refers to a human resource, place, or other kinds of resources on which manufacturing or producing activities are based.

The term “environmental load” refers to a negative influence on the environment. The environmental load includes, for example, production of waste, air pollution, water pollution, and soil pollution.

The term “sorting” refers to dividing or classifying things into a plurality of groups. In the present embodiment, the term “sorting” refers to dividing a plurality of orders to a plurality of producers. The processes of sorting may be referred to as, for example, selection, determination, selection of a producer.

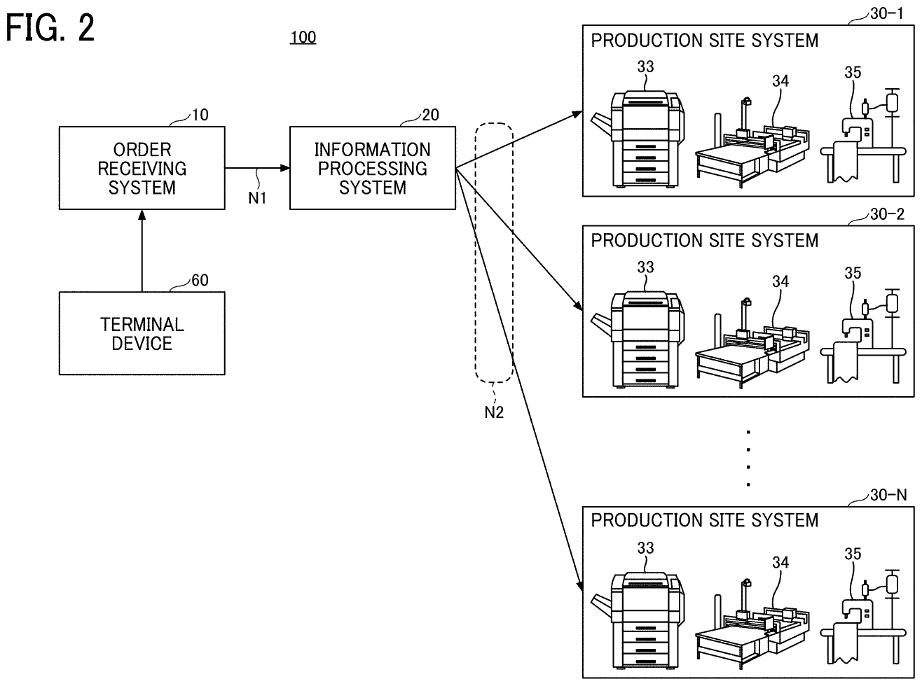

FIG. 2 is a block diagram of an order system 100 according to the present embodiment.

The order system 100 as illustrated in FIG. 2 includes an order receiving system 10, an information processing system 20, and N production site systems 30, where N is greater than 2. The order system 100 and the information-processing system 20 are connected to each other and can communicate with each other through a network N1. The information processing system 20 is connected to each one of the multiple production site systems 30, and the information processing system 20 can communicate with each one of the multiple production site systems 30 through a network N2.

Networks N1 and N2 are wide area networks such as the Internet. Alternatively, the networks N1 and N2 may be, for example, a wide area Ethernet (registered trademark) and a virtual private network (VPN).

The terminal device 60 according to the present embodiment may be terminals such as a desktop personal computer (PC), a laptop personal computer (PC), a smartphone, and a tablet personal computer (PC) that are operated or manipulated by a consumer. The terminal device 60 may be any information processing apparatus as long as a web browser or a native application can be operated thereon and the information processing apparatus can communicate with the order receiving system 10.

The order receiving system 10 according to the present embodiment is implemented by at least one information processing apparatus. The order receiving system 10 is, for example, an EC site. Once a consumer accesses the EC site using the terminal device 60, the order receiving system 10 supplies the terminal device 60 with the screen data used to display a list of products. The order receiving system 10 receives the order information of the product selected by a consumer through the operation made on the terminal device 60.

The order receiving system 10 according to the present embodiment may include a plurality of order receiving systems. Each one of such a plurality of order receiving systems 10 places an order to the information processing system 20 that can handle the product specified in the order. For the sake of explanatory convenience, the product according to the present embodiment is a material of textiles and apparel product such as a cloth. However, no limitation is indicated thereby. For example, the order receiving system 10 is run or managed by a brand owner. The brand owner has the right to use the brand of the product. The brand is typified by a mark or emblem in which credit is expressed, and indicates, for example, a trademark, a company name, and a product name.

It is assumed that the order receiving system 10 according to the present embodiment does not have, for example, a manufacturing establishment and a factory, or has only a small-scale manufacturing establishment or factory even if it does. Accordingly, the order receiving system 10 controls the environmental load, and requests production to a production site with a short lead time through the information processing system 20.

The information processing system 20 according to the present embodiment is implemented by at least one information processing apparatus that receives an order for a product and places the order to the production site system 30. When there are a plurality of orders, the information processing system 20 requests the production system to produce the products such that the sum of the environmental load in the production stage and the environmental load in the transport stage will be minimized. The order receiving system 10 and the information processing system 20 may be formed as a single integrated unit.

The production site system 30 is a facility on the production site side. The production site system 30 according to the present embodiment includes one or more information processing apparatuses that receive an order request, and various kinds of production machines. It is desired that the production site systems 30 be distributed to various places so that the products can be produced near the place where products are consumed. When the product is textiles and apparel product, the production site system 30 according to the present embodiment includes, for example, a printer 33, a cutter 34, and a sewing machine 35. The production site system 30 is sufficient as long as it involves production machines suited to the product, and no limitation is intended thereby. The printer 33 is used to draw graphics in printing such as screen printing and inkjet printing. The printer 33 may adopt any printing method as long as it has a function to draw graphics or patterns on, for example, textiles and apparel product. The cutter 34 cuts the fabric into a shape specified by, for example, a product name. The sewing machine 35 sews a portion of the cut fabric, which is specified by, for example, a product name.

The production site system 30 according to the present embodiment manages the stock or inventories of the material in each production site, the operating conditions of production machines such as the existence or nonexistence of failure and the fullness of consumable items, and the production schedule as to whether the production machines are available. The production site system 30 provides the information processing system 20 with the management data.

When the multiple production site systems 30 are to be distinguished from each other in the following description, subscripts are used as in, for example, “production site system 30-1” and “production site system 30-2.”

The order receiving system 10 and the information processing system 20 may exist on the cloud network or as on-premises equipment. In the present embodiment, it is assumed that the functions of both the order receiving system 10 and the information processing system 20 are implemented on the cloud. The production site system 30 may also exist or be implemented on the cloud except for the production machines.

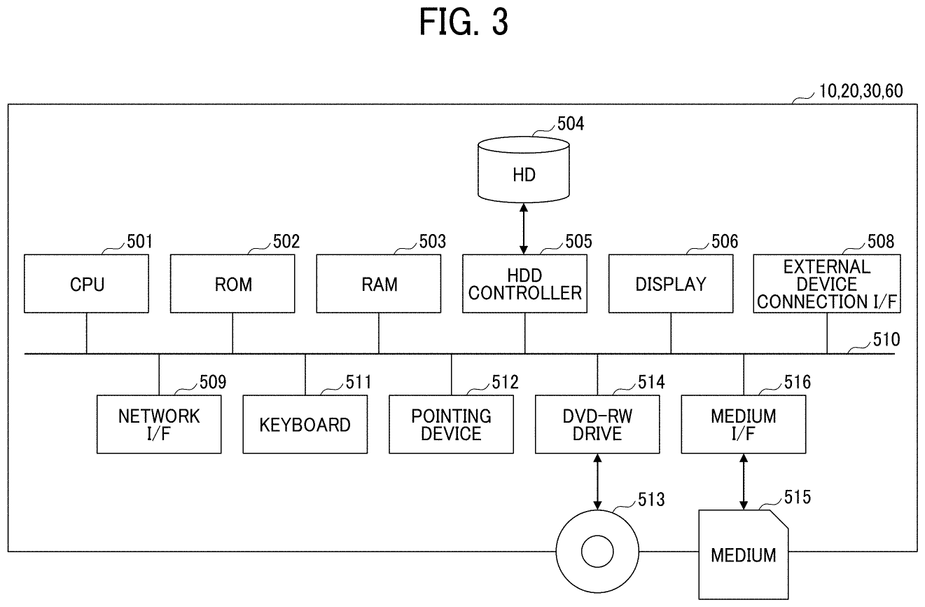

FIG. 3 is a block diagram illustrating a hardware configuration of the order receiving system 10, the information processing system 20, the production site system 30, and the terminal device 60 according to the present embodiment.

As illustrated in FIG. 3, the order receiving system 10, the information-processing system 20, the production-site system 30, and the terminal device 60 are configured by a computer, and as illustrated in FIG. 3, each one of the order receiving system 10, the information-processing system 20, the production-site system 30, and the terminal device 60 includes a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network interface (I/F) 509, a bus line 510, a keyboard 511, a pointing device 512, a digital versatile disk rewritable (DVD-RW) drive 514, and a medium interface (I/F) 516.

Among these elements, the CPU 501 controls all operations of the order receiving system 10, the information process system 20, the production site system 30, and the terminal device 60. The ROM 502 stores a control program such as an initial program loader (IPL) used to drive the CPU 501. The RAM 503 is used as a work area for the CPU 501. The HD 504 stores various kinds of data such as a program. The HDD controller 505 controls reading or writing of various kinds of data to or from the HD 504 under control of the CPU 501. The display 506 displays various kinds of information such as a cursor, menu, window, characters, or image. The external device connection interface 508 is an interface circuit that connects the above devices or systems to various kinds of external devices. The external devices in the present embodiment may be, for example, a universal serial bus (USB) memory and the printer 33. The network interface 509 controls data communication with an external device through the communication network. The bus line 510 is, for example, an address bus or a data bus, which electrically connects various elements such as the CPU 501 illustrated in FIG. 3.

The keyboard 511 is one example of input device provided with a plurality of keys for allowing a user to input, for example, characters, numerical values, and various kinds of instructions. The pointing device 512 is one example of input device for selecting or executing various kinds of instructions, selecting an object to be processed, or for moving a cursor. The DVD-RW drive 514 reads or writes various types of data on a digital versatile disk rewritable (DVD-RW) 513, which is one example of removable recording medium to be controlled. The DVD-RW may be, for example, a DVD-R. The medium interface 516 controls reading or writing of data to or from a recording medium 515 such as a flash memory.

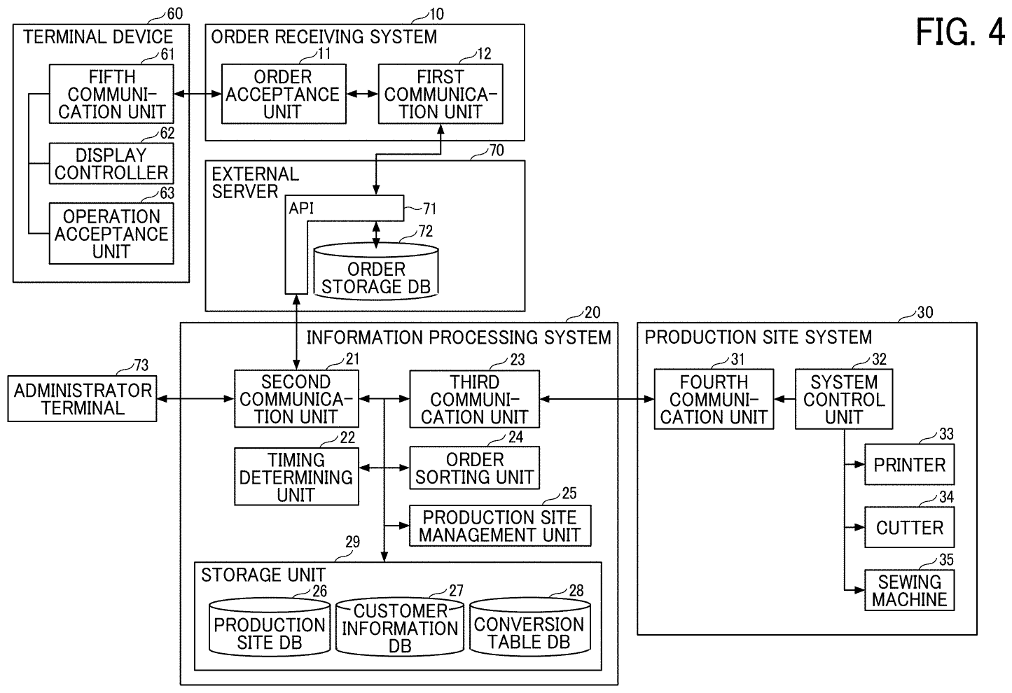

FIG. 4 is a functional block diagram of the order receiving system 10, the information processing system 20, and the production site system 30 according to the present embodiment.

The order receiving system 10 according to the present embodiment includes an order acceptance unit 11 and a first communication unit 12. These units of the order receiving system 10 are functions implemented by or caused to function by operating some of the elements illustrated in FIG. 3 under the control of the instructions from the CPU 501. Note also that such instructions from the CPU 501 are made in accordance with the program expanded from the HD 504 to the RAM 503.

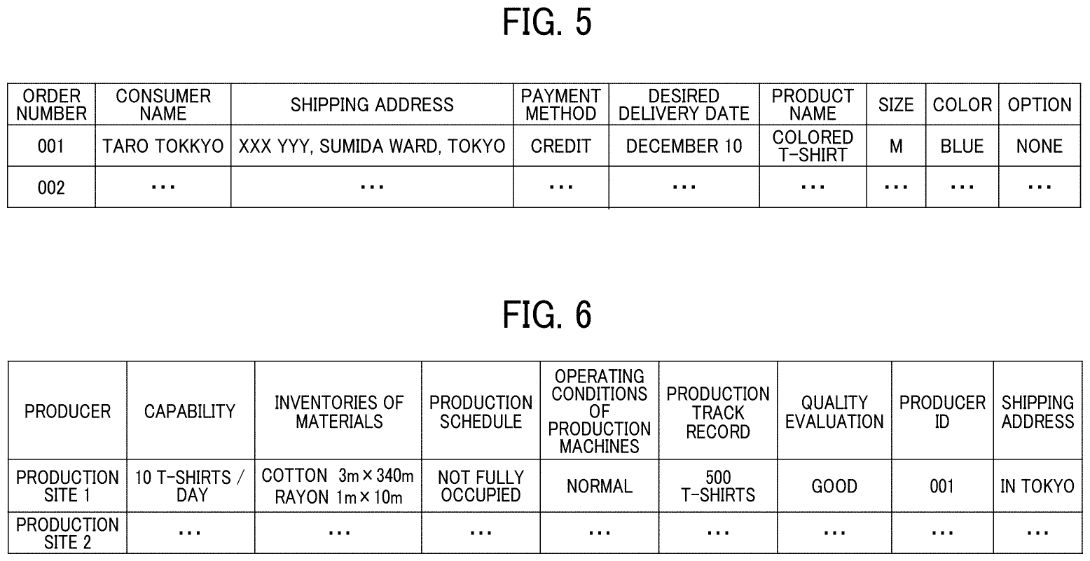

The order acceptance unit 11 provides an EC site and receives the order information of a product purchased by a consumer through a Web browser operated on a terminal device 60. The EC site receives an order through a Web application that is implemented by cooperation between a program executed by a Web server and program executed by a Web browser. The order acceptance unit 11 generates the screen data for a screen to be displayed by a Web browser. The screen data is a program described in, for example, hyper text markup language (HTML), extensible markup language (XML), script language, and a cascading style sheet (CSS). Typically, the structure of the web page is specified by HTML, and the operation of the web page is specified by the script language. Moreover, the style of the web page is determined by the CSS. The order information is described later in detail with reference to FIG. 5. In the terminal device 60, a native application for purchasing a product may operate instead of the web browser.

The first communication unit 12 sends the order information to the external server 70 every time an order is received. Due to such a configuration, the first communication unit 12 can send the order information of the ordered product to the external server 70 immediately after the order is received.

The external server 70 is a server that stores the order information. The external server 70 is implemented by one or more information processing apparatuses. The external server 70 includes an application programming interface (API) 71 and an order storage database (DB) 72. The information processing system 20 can acquire the order information at any desired timing through the API 71. It may be configured such that newly accumulated order information will be sent from the external server 70 to the information processing system 20.

The external server 70 can be managed or run by the information processing system 20. Accordingly, the information processing system 20 may have the order storage database 72. In the present embodiment, the location of the external server 70 may be at any desired place. As the external server 70 is provided separately from the information processing system 20, the information processing system 20 does not have to receive the order information on a one-by-one basis. Accordingly, the processing load on the information processing system 20 can be reduced.

FIG. 5 depicts the order information stored in the order storage DB 72, according to the present embodiment.

A consumer inputs consumer information and order information to a terminal device 60 at the time of purchase. The consumer information is information used to specify a consumer, and includes a consumer name, a shipping address, a payment method, and a desired delivery date. The order information is information used to specify the purchased product, and includes, for example, a product name, a size, a color, and an option. The external server 70 assigns an order number to each item of order information.

The order number indicates the identification data used to uniquely identify an order.

The consumer name is the name or identification (ID) of the consumer who purchased the product.

The shipping address is the destination of the product.

The payment method is a method such as credit, bank transfer, and cash on delivery to pay the purchase price of the product.

The desired delivery date is the deadline for the delivery of the product.

The product name is information such as identification data that specifies a product.

The size is the size of a product such as S, M, and L that denote small, medium, and large, respectively, in the case of textiles and apparel product.

The color is the color ordered by a consumer when there is a product of a different color.

The option denotes, for example, the designation of product with a slightly large size or slightly small size, a method of packaging a product, and the designation of date and time when the product is delivered.

As illustrated in FIG. 4, the information processing system 20 includes a second communication unit 21, a timing determining unit 22, a third communication unit 23, an order sorting unit 24, and a production site management unit 25. These units of the information processing system 20 are functions implemented by or caused to function by operating some of the elements illustrated in FIG. 3 under the control of the instructions from the CPU 501. Note also that such instructions from the CPU 501 are made in accordance with the program expanded from the HD 504 to the RAM 503.

For the sake of explanatory convenience, the information processing system 20 is collectively illustrated as a single unit in FIG. 4. However, no limitation is indicated thereby, and the functions of the information processing system 20 may be divided into a plurality of information processing apparatuses. In a similar manner to the above, the multiple databases (DB) of the storage unit 29 may also be divided into a plurality of information processing devices.

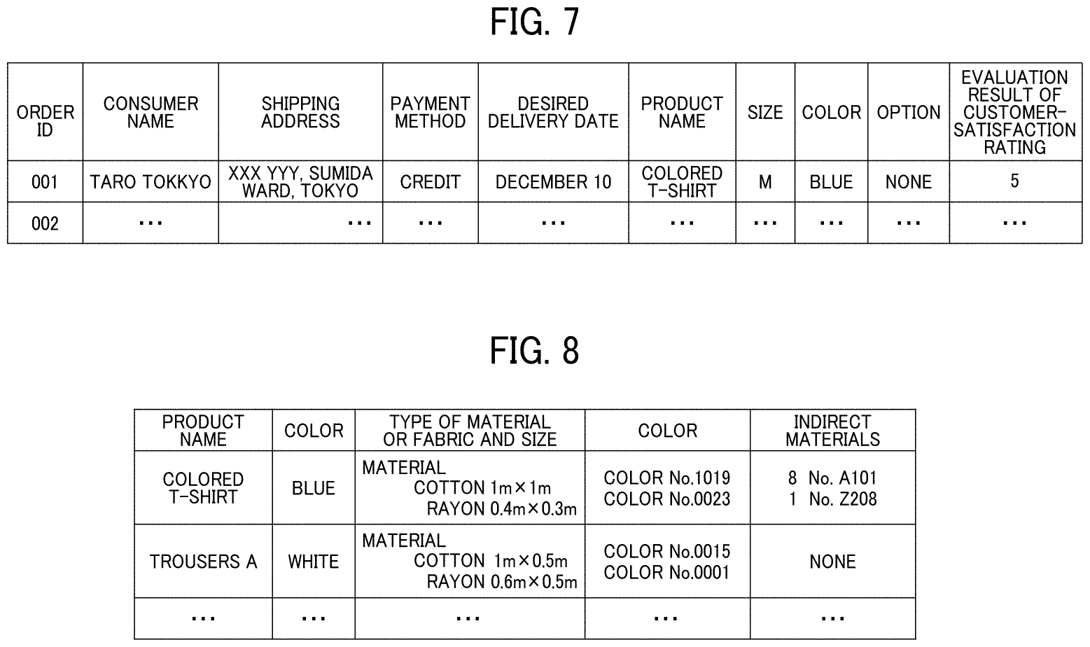

The second communication unit 21 exchanges various kinds of information with the external server 70 and the administrator terminal 73. For example, the second communication unit 21 receives the order information from the external server 70 at the timing determined by the timing determining unit 22. The second communication unit 21 stores the order information in a customer information database (DB) 27 as illustrated in FIG. 7.

The timing determining unit 22 can monitor the order information accumulated in the order storage database 72 through the second communication unit 21. The timing determination unit 22 adopts three methods as will be described later in detail to determine the timing at which the production of ordered product is to start.

When the timing determination unit 22 determines timing at which the production is to start, the order sorting unit 24 selects, from a plurality of production sites, the contractors that are to produce the products specified in a plurality of items of order information accumulated in the order storage database 72. For example, the order sorting unit 24 sorts the contractors that are to produce the products specified in a plurality of items of order information to the production site systems 30-1 to 30-N such that the sum of the environmental load in the production stage and the environmental load in the transport stage will be minimized. For such sorting, the data that is stored in the production site database 26, as will be described later, is used.

The third communication unit 23 sends production request information to the production site system 30 selected by the order sorting unit 24 to request the production of a product.

The production site management unit 25 according to the present embodiment monitors the production site systems 30-1 to 30-N through the third communication unit 23. More specifically, the production site management unit 25 cooperates with an inventory management system and a production scheduler provided for each one of the production site systems 30, and remotely monitors the operating conditions of the production machines to collect information. The production site management unit 25 stores the collected information in the production site database 26.

The information processing system 20 according to the present embodiment includes a storage unit 29 that is implemented by at least one of the HD 504, the RAM 503, and the ROM 502 as illustrated in FIG. 3. The storage unit 29 includes a production site database (DB) 26, a customer information database (DB) 27, and a conversion table database (DB) 28.

FIG. 6 illustrates the production site information stored in the production site database 26, according to the present embodiment.

The production site database 26 includes information on the production site. The production site database 26 includes a plurality of items including a producer or manufacturer, capability, a stock or inventory of materials, a production schedule, the operating conditions of production machines, production track record, quality evaluation, producer ID, and a shipping address.

The producer is, for example, a company name of the producer.

The capability is the volume of production of each product per unit time. For example, the number of T-shirts that can be produced per hour is registered. The capability also includes the information as to which product can be produced by the producer.

The inventory of materials is the amount of stock of materials used for a product. Not only the material itself but also dyeable colors and sub-materials possessed by the production site are included in the materials.

In a simplified manner, the production schedule indicates whether the production machines is currently available. More specifically, the production schedule is a time schedule in which a time zone where the production machines are used for production is registered.

The operation conditions of production machines is the existence or nonexistence of a failure and the remaining amount of each consumable item.

The production track record is information indicating how many products are produced for each ordered product, for example, for each month in the past. This information may be used for billing. The production track record may include information as to whether the delivery dates are met.

The quality evaluation indicates an evaluation result of the customer-satisfaction rating from customers. For example, the evaluation result of the customer-satisfaction rating is an average of five-level evaluations. The quality evaluation may be a ratio of the number of claims to the number of shipped products.

The producer ID is the identification data of a producer.

The shipping address is an area to which the producer delivers the product.

The producer of the production site system 30 can register the information about the producer with the information processing system 20. For example, a producer who has newly introduced facilities or human resource can register information indicating that the production site can deal with latest products and information indicating that the capability has improved with the information processing system 20. The registered information can also be reflected in the production site database 26.

FIG. 7 is a diagram depicting the customer information stored in the customer information database 27, according to the present embodiment.

The information that is stored in the customer information database 27 is about how each customer placed an order and what each consumer ordered in the past, and is substantially the same as the information stored in the order storage database 72 as illustrated in FIG. 5. In the customer information database 27, an evaluation result of the customer-satisfaction rating is additionally stored.

The evaluation result of customer-satisfaction rating indicates the level of customer satisfaction fed back by consumers about products, and such a level of customer satisfaction is indicated by, for example, numbers in five levels.

FIG. 8 is a diagram depicting a conversion table included in the conversion table database 28, according to the present embodiment.

The conversion table is a table used to convert the product in an order into the information about materials required to produce products. The material information relates to various kinds of materials used to produce products. The material information in textiles and apparel industry includes, for example, the type of fabric, the size of fabric, a coloring material, and a sub-material.

In the conversion table database 28, the type of fabric, the size of fabric, a coloring material, and a sub-material that are required for each product are associated with each other. For example, when the product is a colored T-shirt, the materials of “cotton 1 m×1 m” and “rayon 0.4 m×0.3 m” are required, and the materials are to be colored with color No. 1019 and color No. 0023. Moreover, eight sub-materials of No. A101 and one sub-materials of No. Z208 are required to produce the above product.

As described above, a conversion table is adopted in the present embodiment, and a product that is ordered by a consumer is converted into material information. Due to such a configuration, the information processing system 20 can compare, for example, the amount of stock of fabric that a producer has with, for example, the amount of fabric required to produce the product.

The production site system 30 according to the present embodiment includes, for example, a fourth communication unit 31, a system control unit 32, a printer 33, a cutter 34, and a sewing machine 35. The functions of the fourth communication unit 31 and the system control unit 32, which are included in the production site system 30, are functions implemented by or caused to function by operating some of the elements illustrated in FIG. 3 under the control of the instructions from the CPU 501. Note also that such instructions from the CPU 501 are made in accordance with a program expanded from the HD 504 to the RAM 503.

The fourth communication unit 31 according to the present embodiment receives the production request information from the information processing system 20, and sends the received production request information to the system control unit 32. The system control unit 32 according to the present embodiment is coupled to production machines such as the printer 33, the cutter 34, and the sewing machine 35 that are used to produce a product, and the status or conditions of each production machine is sent from those production machines to the system control unit 32.

The system control unit 32 according to the present embodiment manages the stock or inventories of the material, the operating conditions of production machines such as the existence or nonexistence of failure and the fullness of consumable items, and the future production schedule as to whether the production machines are available. Accordingly, the system control unit 32 controls the workflow of the printer 33, the cutter 34, and the sewing machine 35 based on the production schedule. As known in the art, the producible products differ among production sites due to the differences in capability of the production machines.

The fourth communication unit 31 according to the present embodiment sends the information managed by the system control unit 32 of the production site system 30 to the information processing system 20 on a regular basis. Such information managed by the system control unit 32 includes, for example, capability, a stock or inventory of materials, and a production schedule. More specifically, in response to a request from the information processing system 20, the fourth communication unit 31 according to the present embodiment sends, for example, the capability, the stock or inventory of materials, and the production schedule to the information processing system 20 in real time.

The terminal device 60 is an information processing device operated by a consumer. The terminal device 60 includes a fifth communication unit 61, a display controller 62, and an operation acceptance unit 63. These units of the terminal device 60 are functions implemented by or caused to function by operating some of the elements illustrated in FIG. 3 under the control of the instructions from the CPU 501. Note also that such instructions from the CPU 501 are made in accordance with the program (Web browser or native application) expanded from the RD 504 to the RAM 503.

The fifth communication unit 61 communicates with the order receiving system 10 to receive the screen data of the EC site to be displayed on the display of the terminal device 60. The order information that is input to each screen by a consumer is sent to the order receiving system 10.

The display controller 62 according to the present embodiment analyzes the screen data of the screen received from the order receiving system 10, and displays the analyzed screen data on the display 506. The operation acceptance unit 63 receives the operation made by a consumer on the terminal device 60. For example, the operation input acceptance unit 63 receives the input of order information to each screen.

The administrator terminal 73 is a terminal operated by the manager who is the brand owner. Before the order sorting unit 24 sends a request for production to each of the production site systems 30, a message requesting approval or a message indicating that a request for production will be sent is sent in advance may be sent to a brand owner who sells textiles and apparel products. The administrator terminal 73 is not essential, but the administrator can use the administrator terminal 73 to consider, for example, whether or not to change the production site when a large quantity order is newly expected.

The administrator terminal 73 may be terminals such as a desktop personal computer (PC), a laptop personal computer (PC), a smartphone, and a tablet personal computer (PC) that are operated or manipulated by an administrator. The administrator terminal 73 may be any information processing apparatus as long as a web browser or a native application can be operated thereon and the information processing apparatus can communicate with the information processing system 20.

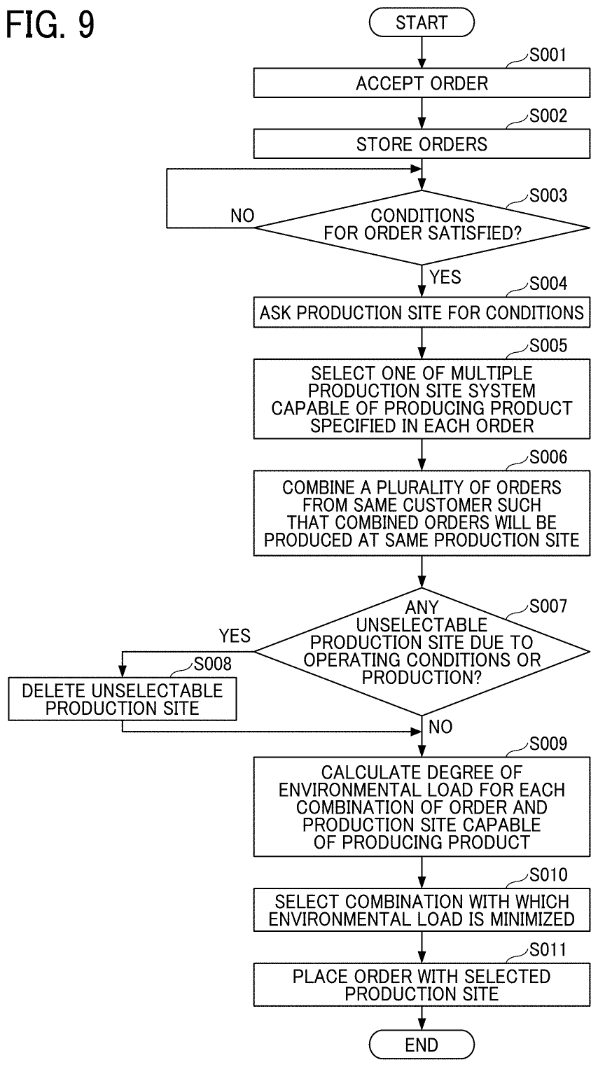

FIG. 9 is a flowchart of the processes of sorting a plurality of items of order information received by the information processing system 20 into groups of orders for each production site at a prescribed timing so as to minimize or at least reduce the environmental load and requesting each of the production sites to produce the products specified by the orders, according to the present embodiment.

The processes of the present embodiments are described below in chronological order.

In a step S001, the order acceptance unit 11 of the order receiving system 10 accepts an order from a consumer. The consumer selects a products to be purchased on the EC site, and inputs information necessary for purchase such as his/her name, a payment method, the shipping address, a desired delivery date, and an option. The order acceptance unit 11 receives these items of order information.

In a step S002, the first communication unit 12 of the order receiving system sends the order information to the order storage database 72. For the sake of explanatory convenience, a situation in which the second communication unit 21 of the information processing system 20 receives the order information from the order storage database 72 is described. The second communication unit 21 generates the order management information based on the order information.

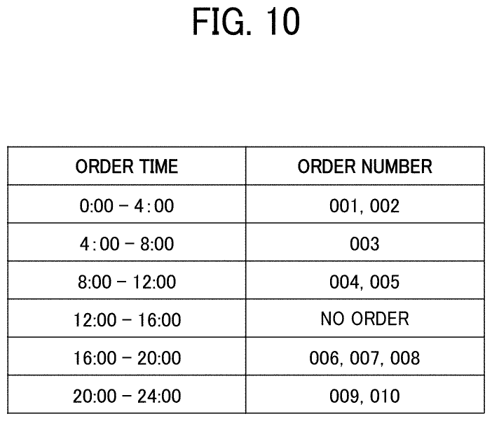

FIG. 10 is a table in which the items of the order management information are listed, according to the present embodiment.

As illustrated in FIG. 10, the order number and the order time are recorded in the order management information.

The order number is identification data used to identify an order. The order number is associated with the order information as depicted in FIG. 5.

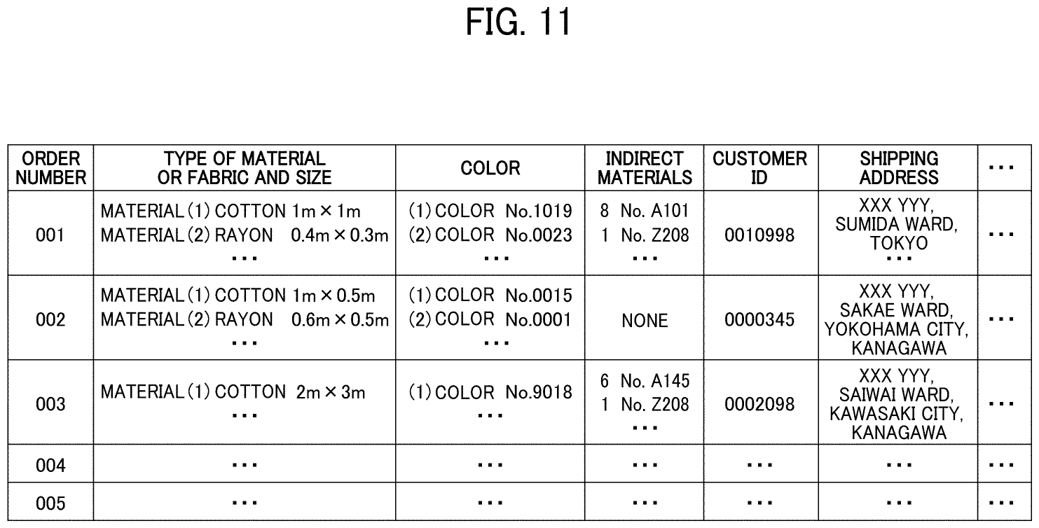

The order time is indicated by a range of time. It is assumed that the information processing system 20 sorts production sites to which orders are placed at regular time intervals. The actual order time may be recorded in minutes. As illustrated in FIG. 11, the product of each order number is converted into material information based on the conversion table of FIG. 8.

FIG. 11 is a diagram depicting a table of the detailed contents of material information obtained as a result of performing conversion on the order information, according to the present embodiment.

The material information includes a plurality of items including, for example, order numbers, the types of fabric, the sizes of fabric, coloring materials, sub-materials, customer ID, and shipping addresses. The order numbers are the same as the order numbers in FIG. 10.

The types of fabric and the sizes of fabric are the types and sizes of the fabric required to produce or manufacture the ordered product.

The color is the color of the fabric required for the ordered product.

The sub-materials do not refer to parts or direct materials of a product, but refer to materials that are required in the manufacturing processes. In the case of textiles and apparel products, the sub-materials may be, for example, buttons, tags, and threads.

The customer ID is identification data of a consumer.

The shipping address is the destination to which the product produced according to the outstanding order is to be delivered.

The order information that is accumulated in the order storage database 72 is managed by the external server 70. For this reason, when the timing determining unit 22 refers to the order information accumulated in the order storage database 72 to determine the timing of order, the order information may be cleared. In order to avoid such a situation, in a step S002, the second communication unit 21 copies and stores the data in the order storage database 72 in the customer information database 27. Due to such a configuration, the information processing system 20 can manage the customer information on a continual basis, and can share information such as customer names, payment methods, shipping addresses, and options.

In a step S003, the timing determination unit 22 determines whether or not the stored order satisfies the conditions for order every time a certain length of time passes. When the stored order satisfies the conditions for order (“YES” in the step S003), the order sorting unit 24 starts the ordering process to the production site. When the stored order does not satisfy the conditions for order (“NO” in the step S003), the order sorting unit 24 determines whether or not the stored order satisfies the conditions for order after a certain length of time passes again. It is assumed in the present embodiment that the timing determining unit 22 performs the above determination once every 15 minutes.

For example, the above determination may be made in the following ways given below.

In the first method, when the number of orders reaches a predetermined number, the timing determining unit 22 causes the order sorting unit 24 to start the ordering process. For example, if it is determined that the order sorting unit 24 places an order when the number of orders reaches 10, order number 010 is registered in the order management information of FIG. 10, and then the order is placed at the timing of the next step S003, which is 15 minutes later.

In the second method, every time a certain length of time passes, the timing determining unit 22 causes the order sorting unit 24 to start the ordering process. For example, it is determined that the order sorting unit 24 places an order when 12 hours have passed from 0:00. In the case of FIG. 10, the orders of order numbers 001 to 005 that are registered from 0:00 to 12:00 are placed at the timing of the next step S003 after 12:00, which is 15 minutes later.

In the third method, the timing determining unit 22 causes the order sorting unit 24 to start the ordering process on a daily basis at a specified time. For example, when the order sorting unit 24 places an order at 20:00 every day, in the case of FIG. 10, the orders of order numbers 001 to 008 are placed at the timing of the next step S003 after 20:00, which is 15 minutes later.

In the first method, the order sorting unit 24 can order a predetermined number of orders or more orders at the same time. Accordingly, the area of imposition on fabric can easily be increased, and the amount of disposal of fabric can be reduced. However, if it takes a long time for the number of orders to reach the predetermined number, the delivery to the consumer tends to be delayed. In the second and third methods, the length of time between the receipt and placement of an order from the consumer does not become long. However, there is a possibility that the amount of disposal of fabric becomes large. In order to handle such a situation, in the present embodiment, a hybrid timing determination method is adopted that is based on the second method in which an order is placed every time a certain length of time passes. In such a hybrid timing determination method, the first method is also adopted in which the orders are placed when the number of orders reaches a predetermined number before the certain length of time passes. In other words, the order sorting unit 24 places orders at either timing of when the number of orders reaches a predetermined number or when a certain length of time passes.

When the conditions for order are satisfied, in a step S004, the production site management unit 25 makes an inquiry in real time to the multiple production site systems 30-1 to 30-N through the third communication unit 23 as to the stock or inventories of the material in each production site, the operating conditions of production machines such as the existence or nonexistence of failure and the fullness of consumable items, and the production schedule as to whether the production machines are available. The fourth communication unit 31 of each one of the production site systems 30 acquires the latest information from the system control unit 32, and sends the acquired latest information to the information processing system 20. The third communication unit 23 receives the latest information, and the production site management unit 25 according to the present embodiment stores the stock or inventory of materials, the operating conditions of production machines, and the production schedule in the production site database 26. Due to such a configuration, the order sorting unit 24 according to the present embodiment can refer to the production site database 26 to figure out the latest status or conditions of each of the multiple production-site systems 30.

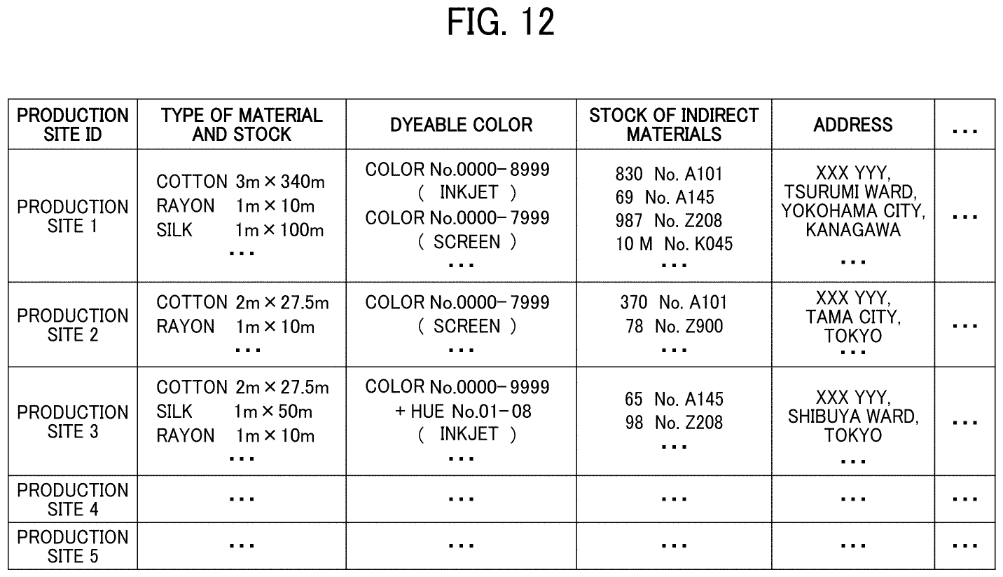

In a step S005, the order sorting unit 24 selects one of the multiple production site systems 30 capable of producing the product specified in each one of the orders of order numbers 001 to 010. The order sorting unit 24 performs such selection based on the table of FIG. 11 depicting the material information of the product specified in the order and the table of FIG. 12 depicting the capability of each one of the multiple production sites. The order sorting unit 24 excludes a production site system in advance that is not capable of producing an ordered product.

For the sake of explanatory convenience, it is assumed in the present embodiment that three items of information including the size of fabric, a coloring material, and a sub-material represent the product. In FIG. 11, items of the information about materials that are required for a product are listed for each order number. For example, the specifications of the product that are necessary for the production sites to produce the product specified in the order of order number 001 are as follows. Cotton materials of 1 meter (m)×1 m are necessary, and rayon materials of 0.4 m×0.3 m are necessary. The color materials required for dyeing are color No. 1019 and color No. 0023. In these color numbers, each number is associated with a specific color on a one-by-one basis. As sub-materials, eight items of A101 and one item of Z208 are necessary, where A101 and Z208 denote specific buttons and tags, respectively.

In FIG. 12, the capability of each item of the material information at each production site is recorded.

FIG. 12 is a diagram depicting the production site data according to the present embodiment.

The production site data in the present embodiment includes a plurality of items including production site identification (ID), the types of fabric and the stock or inventory of the fabric, dyeable colors, the inventory of sub-materials, and location.

The production site ID indicates identification data used to identify the production site.

The types of fabric and the stock or inventory of the fabric indicate stock or inventory of the fabric held at the production site. For example, the production site 1 holds the stock or inventory of cotton material in size of 3 meters (m)×340 m.

The dyeable color indicates the type of color that is available at the production site and can be used to dye the fabric.

The inventory of the sub-materials is the stock of the sub-materials stored at the production site.

Location indicates the location of a production site.

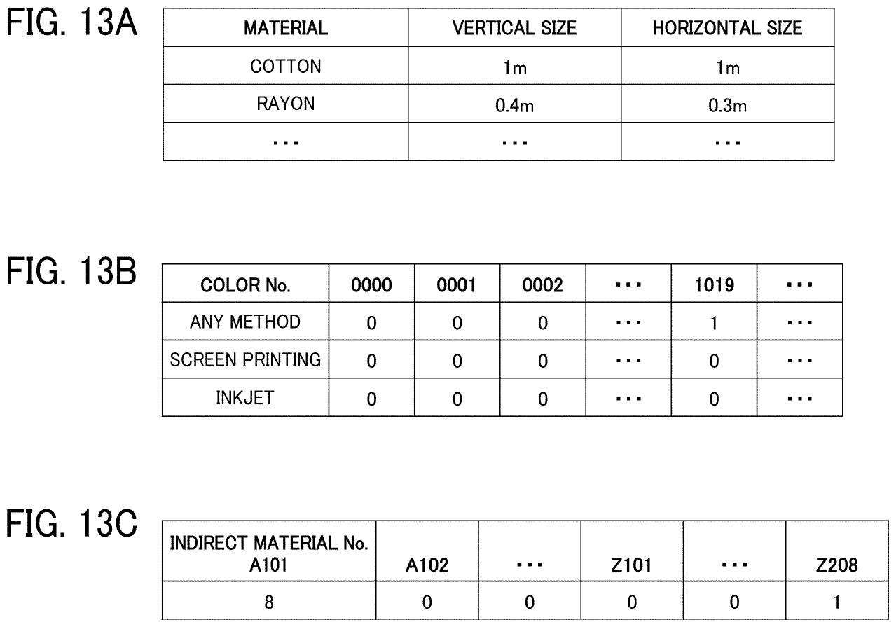

The order sorting unit 24 according to the present embodiment refers to the material information as depicted in FIG. 11 and the capability information as depicted in FIG. 12. Firstly, the order sorting unit 24 reads the material information as depicted in FIG. 11 including the types of fabric, the sizes of fabric, coloring materials, and sub-materials, and arranges the read material information in the three matrix tables as depicted in FIG. 13A, FIG. 13B, and FIG. 13C.

FIG. 13A is a table in which types of fabric are listed in the row direction and vertical and horizontal sizes are listed in the column direction.

FIG. 13A is a diagram depicting a table in which the types of fabric necessity to produce the ordered product and the size of each type of fabric are specified, according to the present embodiment. For example, as the types of fabric necessary for the order of order number 001 are cotton and rayon, the required size is input for each one of the materials.

FIG. 13B is a table in which dyeing methods are arranged in the row direction and the color numbers are arranged in the column direction.

In FIG. 13B, the color of dye that is necessary for production machines to dye the fabric in the processes of producing or manufacturing the ordered product is specified. The necessary color is expressed by 1, and the unnecessary color is expressed by 0. For example, 1 is input to the cell of No. 1019 that is a color necessary for the product of order number 001, and 0 is input to the cell of No. 0000 that is a color unnecessary for the product of order number 001.

A consumer may select a dyeing method in the order receiving system 10. In FIG. 13B, inkjet or screen printing is selected. Unlike the screen printing, the inkjet does not require any waste water treating. When a consumer wishes to choose a dyeing mode, inkjet is to be selected at the time of order placement. When a dyeing method is selected, 1 is input to the row of the corresponding dyeing method. When no particular dyeing method is desired, 0 is input to the row of any method.

FIG. 13C is a table indicating the number of items of each type of sub-material required for the ordered product, according to the present embodiment.

For example, in the order of order number 001, eight sub-materials of sub-material No. A101 are required, and one sub-material of sub-material No. Z208 is required. Accordingly, numbers each of which indicates the required number are input to the cells below the corresponding sub-material numbers.

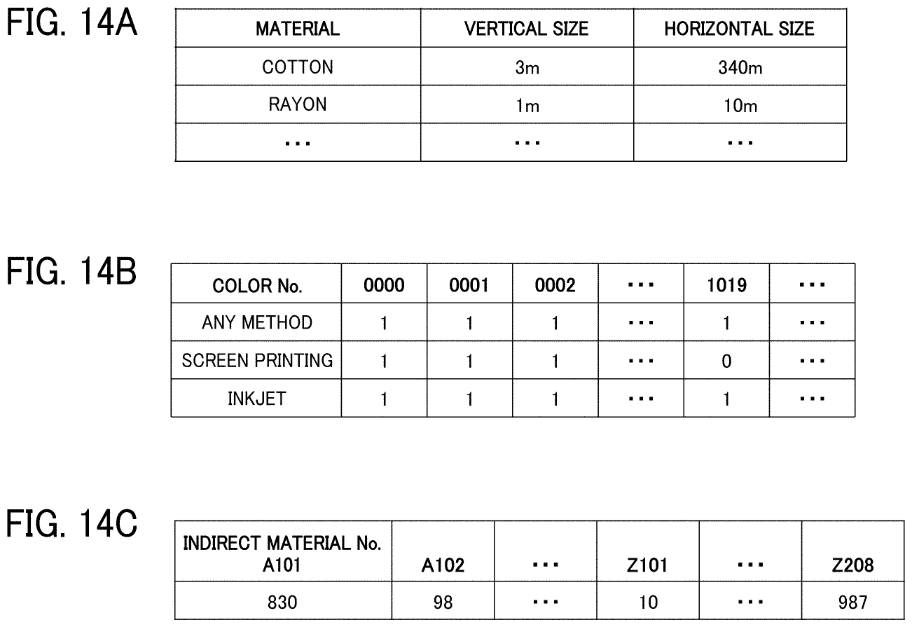

The order sorting unit 24 according to the present embodiment reads the capability for each production site from the table of capability as depicted in FIG. 12, and arranges it in three matrix tables as depicted in FIG. 14A, FIG. 14B, and FIG. 14C.

FIG. 14A, FIG. 14B, and FIG. 14C are matrix tables in which several items of capability in view of types of fabric, sizes, colors, and sub-materials are arranged, according to the present embodiment.

The tables of FIG. 14A, FIG. 14B, and FIG. 14C have the same structure as the tables of FIG. 13A, FIG. 13B, and FIG. 13C, respectively. By way of example, the information of the production site 1 is input. For example, as illustrated in FIG. 12, the production site 1 has 3 m×340 m stock of cotton materials, and 3 m and 340 m are input as the vertical size and the horizontal size of cotton materials in the table of FIG. 14A. In FIG. 14B, 1 is input to the cells of color numbers that the production site 1 can deal with, and 0 is input to the cells of color numbers that the production site 1 cannot deal with. In FIG. 14C, the number of stocks of each sub-material available at the production site 1 is input.

Although the tables of FIG. 13A, FIG. 13B, and FIG. 13C are generated for each order and the tables of FIG. 14A, FIG. 14B, and FIG. 14C are generated for each production site, the structures of the three pairs of tables and the arrangement or order of the materials, sizes, color numbers, and sub-materials are equivalent to each other.

The order sorting unit 24 generates the tables of FIG. 13A, FIG. 13B, and FIG. 13C for each order, and generates the tables of FIG. 14A, FIG. 14B, and FIG. 14C for each production site. Upon generating the tables as above, the order sorting unit 24 performs calculations for all combinations of orders and production sites. For example, when there are 10 orders of order numbers 001 to 010 and N production sites 1 to N, the order sorting unit 24 performs calculations for 10×N combinations.

Such calculations are performed as follows.

Firstly, the order sorting unit 24 compares the input values at the same position on a pair of tables with each other in regard to the three pairs of tables as illustrated in FIG. 13A, FIG. 13B, FIG. 13C, FIG. 14A, FIG. 14B, and FIG. 14C. When the values in the table of FIG. 13A, FIG. 13B, and FIG. 13C are equal to or smaller than the values in the tables of FIG. 14A, FIG. 14B, and FIG. 14C, the value of 1 is output. Otherwise, the value of 0 is output. For example, when such comparison is performed for the combination of order 1 and production site 1, the vertical size of cotton in FIG. 13A is 1 m, and the vertical size of cotton at the production site 1 is 3 m. As the values in the table of FIG. 13A are equal to or less than the values in the table of FIG. 14A, the value of 1 is output. In a similar manner to the above, as color No. 0000 in FIG. 13B is unrelated to the order, the input value is 0.

1 is indicated for color No. 0000 in FIG. 14B, which means “dyeable.” As the values in the table of FIG. 13B are equal to or less than the values in the table of FIG. 14B, the value of 1 is output. As described above, when the order sorting unit 24 performs the above comparison and computation on each pair of items at the same corresponding position between the tables of FIG. 13A, FIG. 13B, and FIG. 13C and the tables of FIG. 14A, FIG. 14B, and FIG. 14C, 1 is output for the same positions of all the three tables for the combination of the order of order number 001 and the production site 1.

Subsequently, the order sorting unit 24 multiplies all the output values of the three tables. As all the output values indicate the value of 1 for the combination of the order of order number 001 and the production site 1, the result of multiplication becomes 1. By contrast, when any one of the values in the tables of FIG. 13A, FIG. 13B, and FIG. 13C is greater than the corresponding one of the values in the tables of FIG. 14A, FIG. 14B, and FIG. 14C, the value of 0 is included in the output values, and the result of multiplication becomes 0. When any one of the values in the tables of FIG. 13A, FIG. 13B, and FIG. 13C is greater than the corresponding one of the values in the tables of FIG. 14A, FIG. 14B, and FIG. 14C, it means that the relevant production site does not have the capability for producing the ordered product. The capability relates to the availability of materials, the types of color, and the availability of sub-materials. Due to such a configuration, the order sorting unit 24 can determine whether the ordered product can be produced at that production site depending on whether the result of multiplication is 1 or 0.

The above computation is expressed in a formula given below.

Πf(Mij,Nxy)

Π denotes a total multiplication symbol, and Mij denotes i-th row and j-th column of a table M (see FIG. 13A to FIG. 13C) related to the order. Nxy denotes x-th row and y-th column of a table N (see FIG. 14A to FIG. 14C) related to the production site, and function f (a, b) denotes a function meaning that 1 is to be output when a≤b and 0 is to be output in the other cases.

In the processes as described above, the order sorting unit 24 completes the processes in the step S005, and as illustrated in FIG. 15, specify a production site capable of producing the product specified in each one of the orders.

FIG. 15 is a diagram depicting a table of production sites capable of production that are determined for five orders of order numbers 001 to 005, according to the present embodiment.

For example, the products of order number 001 can be produced at the production site 1 and the production site 3. The products of order number 002 can be produced at the production site 2 and the production site 3. The products of order number 003 can be produced at the production site 2, the production site 3, the production site 5, and the production site 7. The production site 4 can produce the product of order number 004. The products of order number 005 can be produced at the production site 3 and the production site 5.

Subsequently, in a step S006, the order sorting unit 24 determines whether or not there are a plurality of orders from the same customer. If there are a plurality of orders, the order sorting unit 24 attempts to aggregate the production sites. More specifically, the order sorting unit 24 uses the order management information as illustrated in FIG. 10 to determine whether there is any order that involves the same customer ID and shipping address among a plurality of orders placed at the same time. If there is any order that involves the same customer ID and the same shipping address, the order sorting unit 24 checks whether or not it is possible to consolidate the production sites in the table of FIG. 15. When it is possible to perform consolidation, the order sorting unit 24 consolidates the multiple production sites.

For example, if the customer ID and the shipping address are the same between order number 001 and order number 002, the order sorting unit 24 selects the production site 3 that can be used in common to between both orders. In other words, the order sorting unit 24 determines whether or not there is any production site that can be used in common for a plurality of orders with the same customer ID and the same shipping address.

The information processing system 20 performs the above processes because, as known in the art, the environmental load due to the transportation can be reduced if the delivery from the production site to the shipping address can be consolidated. Even if the customer ID and the shipping address are the same, no consolidation process is performed when the production sites that can produce the product are not in common.

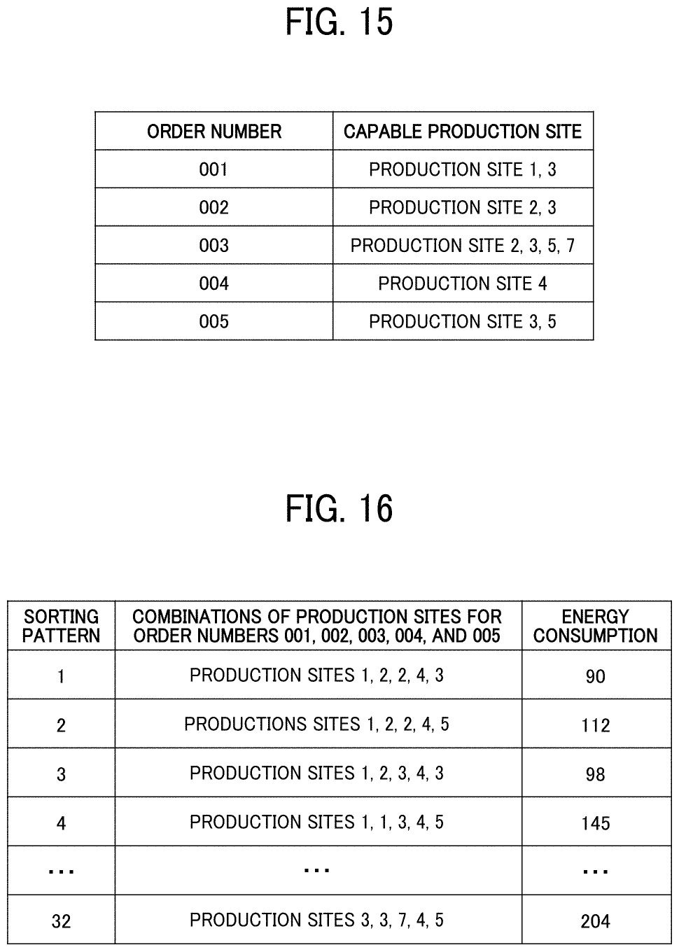

Subsequently, in a step S007, the order sorting unit 24 excludes the production sites that can not produce the product specified in the order, from the options that are the production sites that can produce the product as specified in the step S005. Based on the latest status of each of the production sites figured out by the order sorting unit 24 in the step S004, the stock or inventories of the material in each production site, the operating conditions of production machines such as the existence or nonexistence of failure and the fullness of consumable items, and the production schedule as to whether the production machines are available can be figured out. Based on what is figured out as above, the order sorting unit 24 checks the production sites listed in the table of FIG. to see whether there is any production site in which some production machines are in poor condition, the amount or number of consumable items such as ink for printing an image on the cloth and threads used for sewing is smaller than specified quantity, or the production schedule is full for a certain length of time. Such selection based on the conditions as above can be performed by various kinds of known algorithms. The processes in the step S007 may be performed prior to the step S005. In such cases, the number of sorting patterns as depicted in FIG. 16 can be reduced, and the processing load on the information processing system 20 to compute the environmental load can be reduced.

When a production site is found that cannot produce the product is found, in a step S008, the order sorting unit 24 deletes the production site from the table of FIG. 15.

Subsequently, in a step S009, the order sorting unit 24 calculates the degree of environmental load for each one of the combinations of the orders and the production sites as tabulated in FIG. 15. In the case of FIG. 15, there are two options for the production site for the order of order number 001, and there are two options for the production site for the order of order number 002. Moreover, there are four options for the production site for the order of order number 003, and there are one option for the production site for the order of order number 004. Further, there are two options for the production site for the order of order number 005. Accordingly, there are thirty-two combinations of sorting patterns (2×2×4×1×2=32). The order sorting unit 24 calculates the environmental load for each one of the 32 patterns.

In the present embodiment, two kinds of data including the environmental load in the production stage and the environmental load in the transport stage are calculated, and the obtained two kinds of data are converted into values in the same measurement unit. Then, the obtained two values are added up. As a result, the degree of environmental load can be obtained. The order sorting unit 24 according to the present embodiment converts the environmental load in the production stage and the environmental load in the transport stage into values indicating a degree of energy consumption. By so doing, a value that indicates a degree of environmental load, which includes the environmental load in the production stage and the environmental load in the transport stage, can be calculated and obtained.

In the present embodiment, the order sorting unit 24 may also calculate other kinds of environmental load such as the environmental load in the production stage of materials in addition to the environmental load in the production stage and the environmental load in the transport stage. In a similar manner to the above, the obtained kinds of data are converted into values in the same measurement unit, and the obtained values are added up. In the present embodiment, the environmental load in the supply chain management (SCM) other than the above environmental load in the production stage and the above environmental load in the transport stage may additionally be taken into consideration. The order sorting unit 24 may calculate the environmental load based on either one of the environmental load in the production stage and the environmental load in the transport stage.

The environmental load in the production stage according to the present embodiment is obtained as a result of adding up the following values by the order sorting unit 24.

Area of fabric to be thrown away in the production stage×Energy consumption per unit area required to produce the fabric

Length of time required to produce the product×Energy consumption per unit time required to operate production machines

Waste water caused by the operation of production machines and energy consumption required for purifying or recycling, for example, used consumables or containers

The area of fabric to be thrown away in the production stage is calculated as follows. Firstly, the ordered product is placed on the fabric. Then, the order sorting unit 24 uses imposition software to add up the areas that are not used when the product is placed on the fabric. Any known imposition software may be adopted in the embodiments of the present disclosure. The above imposition software may be installed in a computer in one of the multiple production sites or may exist as software on the cloud. The area of fabric to be thrown away in the production stage is almost constant depending on the product, the size of the product, and the number of products to be produced at one time. Accordingly, the information processing system 20 may have a table of the area of fabric to be thrown away in the production stage, which is associated with products, the sizes of the products, and the numbers of products produced at one time, in advance.

Regarding the energy consumption per unit area required to produce the fabric, it is satisfactory as long as the order sorting unit 24 keeps the values measured from a typical device or apparatus used to produce the fabric. By contrast, the energy consumption per unit time required to operate production machines and the waste water caused by the operation of production machines and the energy consumption required for purifying or recycling, for example, used consumables or containers vary for each production machine or each purifying or recycling apparatus. In order to deal with such a situation, at each one of the production sites, the degree of energy consumption of each production machine is registered in the system, and the registered degree of energy consumption is held by the order sorting unit 24.

The “environmental load in the transport stage” according to the present embodiment is calculated and obtained by the order sorting unit 24 based on the equation given below.

Energy consumption per unit transport distance of transportation×Length or route or travel distance between production site and shipping address

The energy consumption per unit transport distance of transportation varies for each type of transportation such as a vehicle or a drone. In order to handle such a situation, the degree of energy consumption of each type of transportation at each one of the production sites is registered in the system, and the registered degree of energy consumption is held by the order sorting unit 24. When transportation is not provided and the production site outsources the transportation, each one of the production sites registers the energy consumption per unit transport distance of a typical vehicle for delivery service with the system.

In the case of such a vehicle, the travel distance between the production site and the shipping address is the length of route along the road. The value of such travel distance can be obtained as follows. The order sorting unit 24 makes use of any known path finding service, and input the address of the shipping address and the location of the production site to the system. Then, an option of vehicle is selected and a search is performed. By so doing, the value of such travel distance can be obtained. More specifically, the order sorting unit 24 is accessible to the path finding service on the cloud, and sends the addresses of the shipping address and the production site to the path finding service as part of the processes in the step S009. As a result, the value for the length of route can be obtained. The shipping address is included in the order information at the time of order (recorded in the customer information database 27), and the location of the production site is recorded in the production site database 26 at the time of system registration of the production site (also available as the latest information). On the other hand, in the case of transportation by a drone in a suburb, the transportation is made in a straight line. For this reason, the order sorting unit 24 inputs the coordinates of the production site and the shipping address to obtain the distance in a straight line. As described above, the route is calculated and obtained upon selecting an appropriate method for each type of transportation.

As described above, according to the present embodiment, two kinds of data including the environmental load in the production stage and the environmental load in the transport stage can be computed in the same measurement unit of energy consumption. The order sorting unit 24 computes two kinds of data including the energy consumption in the production stage and the energy consumption in the transport stage for each combination of orders and production sites, and the obtained values are added up. In other words, for all combinations of a plurality of orders and the production sites with at least some items in stock, the order sorting unit 24 computes the environmental load in the production stage of the product and the environmental load in the transport stage where the product is transported to a consumer, and sorts the multiple orders to at least one of the production sites with the smallest sum of the two values of environmental load.

As a result, the order sorting unit 24 can acquire the environmental load as a value indicating the degree of energy consumption for each one of the thirty-two sorting patterns.

FIG. 16 is a table depicting the environmental load for each of the thirty-two sorting patterns, according to the present embodiment.

For example, in the case of the first sorting pattern, the order sorting unit 24 sums up the following values.

The value of energy consumption when the product of order number 001 is produced at the production site 1 and transported to the shipping address

The value of energy consumption when the product of order number 002 is produced at the production site 2 and transported to the shipping address

The value of energy consumption when the product of order number 003 is produced at the production site 2 and transported to the shipping address

The value of energy consumption when the product of order number 004 is produced at the production site 4 and transported to the shipping address

The value of energy consumption when the product of order number 005 is produced at the production site 3 and transported to the shipping address

The value of energy consumption when the first sorting pattern is selected is calculated as 90.

The processes in the step S009 are completed as the order sorting unit 24 performs the above calculation for all of the thirty-two sorting patterns and records the result of calculation in the table of FIG. 16.

In a step S010, the order sorting unit 24 selects a pattern with the smallest energy consumption calculated in the step S009 from thirty-two patterns. When there are a plurality of patterns with almost equal energy consumption, the production site that can promptly start the production in view of a production schedule is selected. The processes of selecting the pattern with the smallest energy consumption and the processes of selecting the production site that can promptly start the production can be implemented by any known numerical sorting method.

In a step S011, the order sorting unit 24 places each order to one of the production site systems 30 through the third communication unit 23 according to the pattern selected in the step S010. As described above, when the order is placed, the information processing system 20 may send information or a request for approval to the administrator terminal 73.

The description of the series of processes according to the embodiments of the present disclosure is as given above. In the present embodiment, the degree of energy consumption is used as a measurement unit to measure or indicate the degree of environmental load. However, no limitation is indicated thereby, and the information processing system 20 may use other kinds of barometer or index such as the amount of carbon dioxide emissions in place of the degree of energy consumption. It is expected that the technologies to evaluate the degree of environmental load will further improve, and any index that appropriately indicates the degree of environmental load and has high measurement accuracy may be selected in the future as desired.

In the present embodiment, the order receiving system 10 sorts the orders from consumers. However, no limitation is indicated thereby, and the structure or configuration of the above embodiments of the present disclosure may be applied to systems for requests for production by an manager. In such cases, the order receiving system 10 and the shipping address are read as a request-for-production input unit to be used by a brand owner and a store selected by the brand owner, respectively, and the information processing system 20 performs the processes similar to those of FIG. 9.

In place of the production or manufacturing in the textiles and apparel industry, the structure or configuration of the above embodiments of the present disclosure may be applied to the production or manufacturing of various kinds of products that requires production and transportation.

First Modification of Embodiment

In the above embodiments of the present disclosure, when the order sorting unit 24 selects a production site in the step S005, the result of multiplication in the computation based on the tables of FIG. 13A, FIG. 13B, and FIG. 13C and the tables of FIG. 14A, FIG. 14B, and FIG. 14C becomes 0 for any one of the production sites that lacks even a single sub-material necessary for a product, and such a production site is out of selection and is never selected. However, in actually, even if, for example, the buttons do not completely match, it is likely that some consumers do not mind as long as the external appearances or sizes of the buttons are reasonably close.

If any one of the multiple production sites retains a large number of sub-materials so as to be selected, a large number of sub-materials that are stored, and some of those excessive sub-materials are actually not used. This increases the environmental load, and the cost of managing or maintaining the production site and the warehousing space that is required to store the stock also increase.

In order to handle such a situation, in the present modification of the above embodiments of the present disclosure, even if any of the sub-materials to be used for the product is not retained in an exact manner, it is arranged such that the production sites retaining any sub-materials that can be a substitute is selected in the step S005.

More specifically, in the tables of FIG. 13C and FIG. 14C, a classification is performed in advance by, for example, a producer such that a group of sub-materials that can be substitutes for each other will be extracted under common conditions for extraction. In the present embodiment, the group of sub-materials that can be substitutes for each other are grouped by the producer in advance such that the characters of the sub-material numbers on the left are in common. For example, when A101 to A199 are sub-material numbers related to buttons, the designer assigns sub-material numbers A101 to A109 in advance as long as there are nine types of buttons of black color with diameters of 1.5 centimeters (cm). In this case, A10 are characters in common. The buttons of black color with 1.5 cm in diameter are grouped into a group of sub-materials identified by A10.

Due to such a configuration, buttons whose sub-material numbers starting with A10 are grouped. When the number of sub-material groups that can be substitutes for each other is large, the number of characters in common may be reduced to increase the larger number of sub-materials to be grouped. For example, when grouping is done by Z1, ninety-nine types of Z101 to Z199 are grouped.

As described above, in the present modification of the above embodiments of the present disclosure, grouping is performed in advance, and the order sorting unit 24 performs the processes in the step S005 using the table in which some sorts of grouping is done instead of using the tables of FIG. 13C and FIG. 14C on an as-is basis. In a table where some sorts of grouping is done, the numbers in common for a group of sub-materials that can be substitutes for each other are arranged in the column direction and the sum of the values of the group of sub-materials that can be substitutes for each other is input as a numerical value to be used for computation. Such grouping according to the present modification of the above embodiments of the present disclosure is described below in a concrete manner with reference to FIG. 13A, FIG. 13B, FIG. 13C, FIG. 14A, FIG. 14B, and FIG. 14C. A101 to A109 are indicates as A10, and the sum of the values of A101 to A109 is input as a numerical value for A10. Z101 to Z199 are indicated as Z1, and the sum of the values of Z101 to Z199 is input as a numerical value for Z 1.

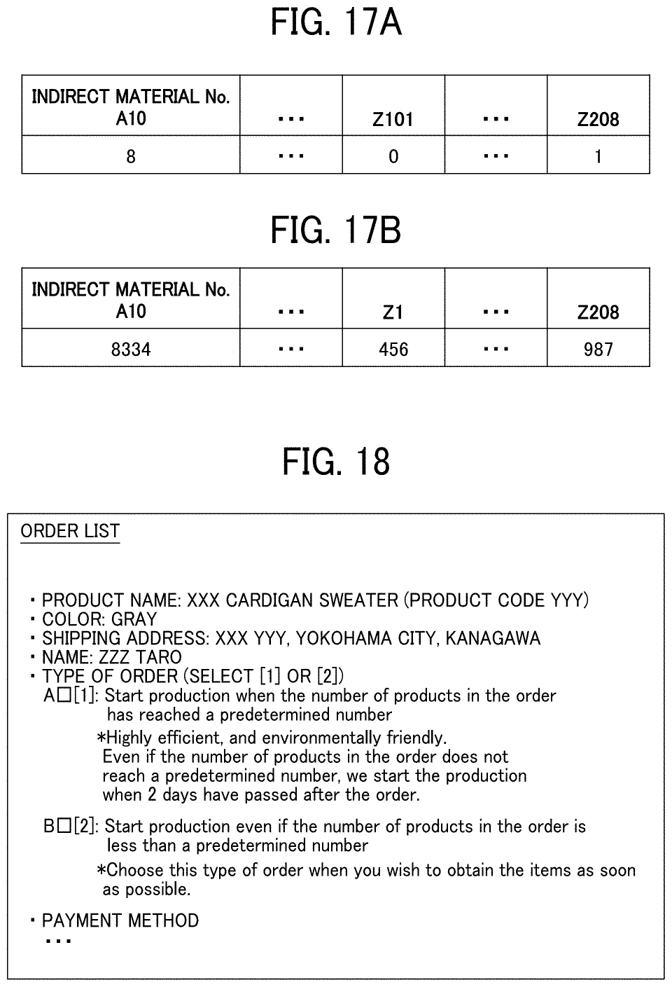

As a result, by way of example, the tables as depicted in FIG. 17A and FIG. 17B are generated as tables corresponding to the tables illustrated in FIG. 13C and FIG. 14C.

FIG. 17A and FIG. 17B are matrix tables where sub-materials are grouped, according to the present embodiment.

FIG. 17A corresponds to FIG. 13C, and FIG. 17B corresponds to FIG. 14C.

As the order sorting unit 24 performs the processes in the step S005 based on the tables of FIG. 17A and FIG. 17B, a production site with sufficient number of sub-materials that can be substitutes for each other, which are included in a group of sub-materials, can be selected as a candidate even if the sub-materials related to the product are not available in an exact manner. When an order is actually placed to such one of the production sites, products are produced at that production site upon replacing the sub-materials to be used for the products with the substitute sub-materials in the grouping of sub-materials.

Second Modification of Embodiment

If the order sorting unit 24 performs the processes in the steps S004 and S005 in FIG. 9 for all of the N production sites, it takes time a long time for computation, and the energy consumed for the processes tends to increase. For the purposes of reducing the environmental load, it is desired that the candidate production sites in the selection be narrowed down in advance. In order to achieve such functions, the order sorting unit 24 according to the present modification of the above embodiments of the present disclosure makes use of the shipping addresses included in the order information to narrow down in advance the candidate production sites that are geographically close to the shipping address, and then the processes in the step S004 and the following steps are performed. The candidate production sites that are geographically close to the shipping address can be extracted in a method as follows.

The order sorting unit 24 extracts the production site in the same district of, for example, prefecture, city, town, and village as the shipping address. Such extraction is implemented as the order sorting unit 24 refers to the shipping address of the customer information database 27 and the location information in the production site database 26.

The order sorting unit 24 extracts a production site in which the length of route between the shipping address and the production site is equal to or less than a predetermined value. Such extraction is implemented as the order sorting unit 24 inputs the shipping address of the customer information database 27 and the location information in the production site database 26 to known external path finding service.

Third Modification of Embodiment

In the step S003 of FIG. 9 according to the above embodiments of the present disclosure, a hybrid timing determination method is adopted, and the order sorting unit 24 places an order when the number of orders reaches a predetermined number or when a predetermined length of time has passed. However, there are consumers who give a high priority to the delivery within a short period of time, and there are other kinds of consumers who give a high priority to low environmental load.

In view of these circumstances, in the present modification of the above embodiments of the present disclosure, a consumer is asked to make selection on the conditions for placing an order when an order is received from the consumer. More specifically, at the time of ordering in the order receiving system 10, the order receiving system 10 causes the terminal device 60 of the consumer to display a screen as illustrated in FIG. 18 to allow the consumer to select the ordering method. The orders are divided into two groups according to the result of selection made by consumers and are sent to the order storage database 72.

FIG. 18 is a diagram illustrating a screen displayed on the terminal device 60 of a consumer to select an ordering method, according to the present embodiment.

A pair of ordering methods A and B are described below.

In ordering method A, the production starts when the number of orders reaches a predetermined number. This ordering method provides high operation efficiency for production machines, and is environmentally friendly.

In ordering method B, the production starts even if the number of orders does not reach a predetermined number. This ordering method is suitable for a customer who wishes to obtain an item in a timely manner.

In such cases, the order storage database 72 is managed separately for each one of the ordering methods A and B selected by the consumer. In the step S003, the timing determining unit 22 starts the ordering process when the number of orders of the consumers who selected the ordering method A reaches a predetermined number, and starts the ordering process every time a certain length of time passes for the orders of the consumers who selected the ordering method B. As a result, both the level of customer satisfaction of the consumers who give a high priority to the delivery within a short period of time and the level of customer satisfaction of the consumers who give a high priority to low environmental load can be increased.

As described above, when there are a plurality of orders, the information processing system 20 according to the present embodiment can select the production site such that the sum of the environmental load in the production stage and the environmental load in the transport stage will be minimized. In view of the production machines, the quantity of waste can be reduced when the products in a plurality of orders are produced or manufactured at once than when a single product is produced in response to every order. In other words, the environmental load in the production stage can be reduced when the products in a plurality of orders are produced or manufactured at once. Accordingly, the possibility that the orders of the same consumer are sorted to the same producer increases, and the environmental load in the transport stage can effectively be reduced.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

For example, the embodiment as illustrated in FIG. 4 relates to the processing that is divided into some major functions or processing units to facilitate the understanding of the processes that are performed by the order receiving system 10, the information processing system 20, and the production site system 30 according to the above embodiments of the present disclosure. The embodiments of the present disclosure are not limited by how the processing is divided into processing units or by the names of the units. The processing of the order receiving system 10, the information processing system 20, and the production site system 30 may be divided into a further larger number of processing units depending on what is to be processed. Such division may be made such that one processing unit includes a larger number of processes.

The groups of devices or apparatuses that are described above as embodiments of the present disclosure are given as an example of a plurality of types of computing environment according to an embodiment of the present disclosure. In some alternative embodiments, the information processing system 20 may include a plurality of computing devices such as server clusters. Such a plurality of computing devices may be configured to communicate with each other through any type of communication link such as a network and a shared memory and to implement the processes described as above as embodiments of the present disclosure.

Further, the information processing system 20 may be configured to share the processing steps disclosed in the above embodiments of the present disclosure such as the steps in FIG. 9 in various kinds of combinations. For example, any processes that are executed by a certain unit may be executed by a plurality of information processing apparatuses provided for the information processing system 20. The information processing system 20 may be integrated into one server device or may be divided into a plurality of devices or apparatuses.

Each of the functions of the described embodiments may be implemented by one or more processing circuits or circuitry. Processing circuitry includes a programmed processor, as a processor includes circuitry. A processing circuit herein includes, for example, devices such as a processor that is programmed to execute software to implement functions, like a processor with electronic circuits, an application specific integrated circuit (ASIC) that is designed to execute the above functions, a digital signal processor (DSP), a field-programmable gate array (FPGA), and a circuit module known in the art.

Any one of the above-described operations may be performed in various other ways, for example, in an order different from the one described above.

Further, as described above, any one of the above-described and other methods of the present disclosure may be embodied in the form of a computer program stored on any kind of storage medium. Examples of storage media include, but are not limited to, flexible disks, hard disks, optical discs, magneto-optical discs, magnetic tape, nonvolatile memory cards, ROM, etc. Alternatively, any one of the above-described and other methods of the present disclosure may be implemented by application-specific integrated circuits (ASICs), prepared by interconnecting an appropriate network of conventional component circuits, or by a combination thereof with one or more conventional general-purpose microprocessors and/or signal processors programmed accordingly.

What is claimed is:

1. An information processing system comprising
circuitry configured to
sort a plurality of orders to at least one production site based on a degree of environmental load when a prescribed condition is satisfied, and
send a request for production of a product, the request being included in each of the plurality of orders, to the at least one production site.

2. The information processing system according to claim 1,
wherein the circuitry is configured to sort the plurality of orders to the at least one production site based on a degree of environmental load in a production stage of the product.

3. The information processing system according to claim 1,
wherein the circuitry is configured to sort the plurality of orders to the at least one production site based on a degree of environmental load in a transport stage in which the product is transported to a consumer.

4. The information processing system according to claim 1,
wherein the circuitry is configured to sort the plurality of orders to the at least one production site based on a degree of environmental load in a production stage of the product and a degree of environmental load in a transport stage in which the product is transported to a consumer.

5. The information processing system according to claim 2,
wherein the circuitry is configured to refer to production site data including information about a stock of a material stored at each one of the at least one production site to determine the at least one production site at which the stock of the material is stored, for each one of the plurality of orders, and
wherein the circuitry is configured to compute the degree of environmental load in the production stage of the product, for each combination of the plurality of orders and the at least one production site at which the stock of the material is stored, and to sort the plurality of orders to the at least one production site with a smallest value for the degree of environmental load in the production stage of the product.

6. The information processing system according to claim 4,
wherein the circuitry is configured to refer to production site data including information about a stock of a material stored at each one of the at least one production site to determine the at least one production site at which the stock of the material is stored, for each one of the plurality of orders, and
wherein the circuitry is configured to compute the degree of environmental load in the production stage of the product and the degree of environmental load in the transport stage where the product is transported to the consumer, for each combination of the plurality of orders and the at least one production site at which the stock of the material is stored, and to sort the plurality of orders to the at least one production site with a smallest sum of a value for the degree of environmental load in the production stage of the product and a value for the degree of environmental load in the transport stage of the product.

7. The information processing system according to claim 5,
wherein the production site data includes information about a stock of a sub-material stored at each one of the at least one production site,
wherein the circuitry is configured to refer to the production site data to determine, for each one of the plurality of orders, the at least one production site at which the stock of the sub-material is stored,
wherein the information about the stock of the sub-material includes information about a plurality of sub-materials that can be substitutes for each other, and
wherein the plurality of sub-materials that can be substitutes for each other are grouped in the information about the stock of the sub-material.

8. The information processing system according to claim 5,
wherein the production site data includes at least one of a capability for the product, a production schedule, and an operating condition of a production machine, and
wherein the circuitry is configured to determine the at least one production site for each one of the plurality of orders based on the at least one of the capability for the product, the production schedule, and the operating condition of the production machine.

9. The information processing system according to claim 5,
wherein the circuitry is configured to ask the at least one production site for the production site data in real time.

10. The information processing system according to claim 1,
wherein the prescribed condition includes both a condition that a number of the plurality of orders reaches a prescribed value and a condition that a certain length of time has passed.

11. The information processing system according to claim 1,
wherein the prescribed condition is one of a condition that a number of the plurality of orders reaches a prescribed value and a condition that a certain length of time has passed, and
wherein whether the prescribed condition is the condition that the number of the plurality of orders reaches the prescribed value or the condition that the certain length of time has passed is to be selected.

12. The information processing system according to claim 1,
wherein the degree of environmental load is a value indicating energy consumption, and
wherein the circuitry is configured to convert a degree of environmental load in a production stage and a degree of environmental load in a transport stage in which the product is transported to a consumer into the value indicating the energy consumption to obtain a value indicating the degree of environmental load including the degree of environmental load in the production stage and the degree of environmental load in the transport stage.

13. An information processing device comprising
circuitry configured to
sort a plurality of orders to at least one production site based on a degree of environmental load when a prescribed condition is satisfied, and
send a request for production of a product, the request being included in each of the plurality of orders, to the at least one production site.

14. A sorting method comprising:
sorting a plurality of orders to at least one production site based on a degree of environmental load when a prescribed condition is satisfied; and
sending a request for production of a product, the request being included in each of the plurality of orders, to the at least one production site.

15. A non-transitory computer-readable recording medium storing a program for causing a computer to execute the sorting method according to claim 14.
